(19) United States
(12) Patent Application Publication
(10) Pub. No.: US 2025/0257623 A1
(43) Pub. Date: Aug. 14, 2025

(54) APPARATUS AND METHOD OF DEPLOYING A PIPE WITHIN A BOREHOLE

(71) Applicant: hyperTunnel IP Limited, Basingstoke (GB)

(72) Inventors: Stephan Jordan, Basingstoke (GB); Patrick Lane-Nott, Banbury (GB); Alan Meeks, Axminster (GB)

(21) Appl. No.: 19/198,004

(22) Filed: May 3, 2025

Related U.S. Application Data
(63) Continuation of application No. PCT/GB2023/051338, filed on May 22, 2023.

(30) Foreign Application Priority Data
Jun. 27, 2022 (GB) 2209405.6

(51) Int. Cl. E21B 23/14; E21B 7/20

(52) U.S. Cl. CPC E21B 23/14; E21B 7/205

(57) ABSTRACT

Lining pipes (103) are routinely pulled through HDD boreholes from one end. As HDD borehole distances get longer, the total amount of friction experienced by the pipe will increase and therefore greater forces/stresses are applied to the pipes (103). For a given material and diameter of pipe (103), conventionally, the only way to handle these stresses is to increase the wall thickness of the pipe (103). The present invention provides at least one gripping device (201) on a line (107), movable through the interior of a pipe (103), and configured to grip an interior of the pipe (103). In this way, the gripping device (201) may be used to grip a pipe (103) at a point spaced from an end thereof, thereby reducing tensile forces on the pipe.

### RELATED APPLICATIONS

This application claims the benefit under 35 U.S.C. § 120, and is a continuation, of co-pending International Application PCT/GB2023/051338, filed May 22, 2023 and designating the US, which claims priority to GB Application 2209405.6, filed Jun. 27, 2022, such GB Applications also being claimed priority to under 35 U.S.C. § 119. These GB and International applications are incorporated by reference herein in their entireties.

### FIELD

The present invention relates generally to an apparatus and method of deploying a pipe within a borehole and finds particular, although not exclusive, utility in completing holes formed with Horizontal Directional Drilling techniques.

### BACKGROUND

Boreholes are routinely lined with pipes in order to improve structural integrity of the bore hole, and protect any items placed downhole (i.e. within the borehole). Such items could include utilities or machinery/equipment either permanently or temporarily downhole. It is well established that such pipes need to withstand external loads including hydraulic pressures, weight of surrounding geology, etc. However, for pipes installed as part of a Horizontal Directional Drilling (HDD) applications such pipes must be designed with additional considerations in mind.

Specifically, where HDD boreholes are lined with a pipe, the lining pipe is pulled through a HDD borehole from one end. Therefore, the pipe must be able to withstand pullback loads that include tensile pull forces and tensile bending stresses. As HDD borehole distances get longer, with longer pipes being pulled through longer bore holes, the total amount of friction experienced by the pipe will increase and therefore greater forces/stresses are applied to the pipes. For a given material and diameter of pipe, conventionally, there is only one way to handle these stresses: namely, to increase the wall thickness of the pipe.

### SUMMARY

One specific problem encountered in the lining of long HDD boreholes is that two or more sections of pipe will need to be joined together in order to form a pipe of sufficient length to line the entire borehole. Conventionally, the joint between each pipe section must also need to withstand these increased forces/stresses.

The pipes themselves may be made from any suitable material, typically PVC, polyethylene, polypropylene, ductile iron, and steel provided that the pipe's properties (wall thickness and material strength) enable it to be both installed and operated (if applicable) under acceptable stress limits.

According to a first aspect of the present invention, there is provided a pipe deploying apparatus comprising: a line suitable for passage down an interior of a pipe to be deployed; at least one gripping device disposed on the line, the gripping device having: a first operational state in which the gripping device is suitable for passage through the interior of the pipe to be deployed; and a second operation state in which the gripping device is configured to grip an interior of the pipe to be deployed.

In this way, the gripping device may be used to grip a pipe at a point spaced from an end thereof, thereby reducing tensile forces on the pipe. In particular, the apparatus may be used in conjunction with a conventional pipe pulling device attached to a leading end of the pipe; in this way, the load due to the pipe may be split between the apparatus and device to reduce tensile forces on the pipe. Avoiding an increase in the thickness of the pipe wall avoids unnecessary costs, particularly in relation to raw materials (e.g. plastic from which the pipe is manufactured), pipe pulling equipment required to pull a heavier pipe and transportation and storage costs.

The line may comprise a cable, chain and/or other suitable line; for example, the line may be strong under tension and/or substantially inextensible, but may be flexible. Alternatively, the line may comprise a shaft, rod and/or other suitable line; for example, the line may be strong under compression and/or substantially uncompressible, and/or the line may be substantially rigid.

The line may have an exterior diameter less than the interior diameter of the pipe. The interior diameter of the pipe may be at least 10 cm, in particular at least 15 cm, more particularly at least 20 cm.

The gripping device may be fixed at a specific location on the line, either permanently or removably fixed. For instance, the gripping device may be fixed to an end of the line, or a location spaced from the ends of the line. In some embodiments, the line may be formed from a first line section on an uphole side of the gripping device, and a second line section on a downhole side of the device, the first and second line sections being coupled to one another via the gripping device (but not directly).

In alternative embodiments, the gripping device may be configured to travel along the line, so that its position on the line can be varied, depending on requirements. In particular, although the gripping device may be manually fixable and removable from any specific location on the line, in some embodiments the gripping device may be configured to travel along the line remotely, such that it can be instructed to travel to a different point along the line subsequent to its insertion into the pipe.

Deploying may comprise pulling and/or pushing the pipe.

Uphole may be defined as a direction in which the line (and therefore the pipe) is to be pulled/pushed through the borehole; similarly, downhole may be defined as a direction in which the pipe is disposed before being pulled/pushed through the borehole.

The first operational state may comprise the gripping device having a lateral extent less than the interior diameter of the pipe. In this context, the lateral direction may be interpreted as at right angles to an axial direction, which in turn is defined as a direction parallel to the longitudinal length of the line and/or pipe. The lateral direction may be interpreted as a radial direction within the pipe. The second operation state may comprise the gripping device having a lateral extent substantially equal to, or in some cases greater than, the interior diameter of the pipe.

For example, the gripping device may comprise at least one inflatable bag, wherein the inflatable bag is in the first operational state when the bag is uninflated, and is in the second operational state when the bag is inflated. The inflatable bag may be elasticated such that the bag is expandable under pressure, and may return to its previous size once the pressure is removed. Alternatively, the inflatable bags may merely fill under pressure and collapse once the pressure is removed.

The gripping device may comprise a pump for inflating the bag. Alternatively, the gripping device may comprise a feed line from a pump disposed elsewhere (such as uphole/downhole).

Alternatively or additionally, the gripping device may comprise at least one arm, the arm movable between the first operational state in which the arm is in a first position, and the second operational state in which the arm is in a second position, the arm in the second position extending from an axis of the gripping device further than the arm in the first position.

The arm may be configured such that tension and/or compression on the line in a first direction (e.g. uphole/downhole) causes the arm to move radially outward from the line, and tension and/or compression on the line in a second direction (e.g. downhole/uphole) causes the arm to move radially inward toward the line. In this way, the gripping device may be moved into place with the line being pulled/pushed in the second direction, and then when required to pull/push the pipe uphole, the line may be pulled/pushed in the first direction. The arm may be biased either inwardly or outwardly, such that its default position is either in the first or second operational state.

As a further optional addition/alternative, the gripping device may comprise at least one wedge, the wedge configured such that tension and/or compression on the line in a first direction (e.g. uphole/downhole) causes the wedge to move radially outward from the line, and tension and/or compression on the line in a second direction (e.g. downhole/uphole) causes the wedge to move radially inward toward the line. In this way, the gripping device may be moved into place with the line being pulled/pushed in the second direction, and then when required to pull/push the pipe uphole, the line may be pulled/pushed in the first direction. The wedge may be biased either inwardly or outwardly, such that its default position is either in the first or second operational state.

Alternatively, the first operational state may comprise the gripping device having a low-resistance contact with the interior of the pipe, for example by engaging with the pipe on skid(s), rotatable wheel(s), track(s), etc. and/or any other form of low-resistance contact(s). The second operation state may comprise the gripping device having a high-resistance contact with the interior of the pipe, for example by engaging with the pipe with high-resistance pad(s), wheel(s) locked against rotation, track(s) locked against movement, pipe-engaging pins/teeth, etc., heating elements to soften the pipe wall (e.g. heated pads, so that friction is increased due to the heating) and/or any other form of high-resistance contact(s). In particular, any wheels and/or tracks may be moveable only in one rotational direction (e.g. to permit only downhole movement), and may be prohibited from movement in another rotational direction (e.g. to prohibit uphole movement). Such locking of wheels/tracks may be controllable (e.g. remotely). In some arrangements, the wheels and/or tracks may be driven to convey the gripping device in a desired direction, and such driving may be controllable (e.g. remotely).

In the context of this application, the terms low-resistance and high-resistance should be interpreted as relating to one another, that is a low-resistance component is to be viewed as having a lower resistance than a corresponding high-resistance component, and vice versa.

Specifically, the first contact and the second contact may be a single contact, for example a wheel may be free to rotate (constituting the first contact) and may be locked against rotation (constituting the second contact), at least in one rotational direction. The first operational state may further comprise movement of the gripping device in a first axial direction, and the second operational state may further comprise movement of the gripping device in a second axial direction.

The single contact may comprise a contact wheel, wherein the wheel is configured to rotate in a first rotational sense only. The wheel may form part of a continuous track propulsion system. The contact wheel may comprise a plurality of contact wheels.

The apparatus may further comprise a line tensioner/compressor configured to ensure that a first tension/compression in a first section of line on a first of the gripping device equals a second tension/compression in a second section of line on a second side of the gripping device. The line tensioner/compressor may be a passive mechanical linkage; however, in alternative embodiments the line tensioner/compressor may comprise an active and/or powered system configured to monitor line and/or pipe tension/compression and to adjust corresponding tensions/compressions accordingly.

The at least one gripping device may comprise a plurality of gripping devices. Accordingly, in applications in which two or more sections of pipe are joined together in order to form a pipe of sufficient length to line an entire borehole, each pipe section may be gripped independently, so each pipe section need only pull/push its own weight and overcome its own resistance. In this way, joints between adjacent pipe sections need only be sufficiently robust to prevent damage from relatively low tension/compression forces (e.g. compared to those that would be encountered when pulling/pushing multiple pipe sections from one end of a completed pipe). This further economy would reduce the time taken to join the pipe sections in situ. In effect, this can make the creation of longer boreholes practical.

Where multiple gripping device are used, the line may be pre-tensioned between each gripping device. In this way, each gripping device may pull on the pipe with an equal force. In the absence of this features, if the line were to extend under tension, a different force would be transferred to each gripping device, and therefore differing forces would be imparted to different parts of the pipe being pulled, potentially to different pipe section, which would put undesirable strain on the pipe section joints.

The plurality of gripping devices may be independently actuatable, or may be part of a system in which all such gripping devices are actuatable at once. The or each gripping device may be actuatable remotely/manually (e.g. via wireless and/or wired communication technology), and/or may be automatic. The or each gripping device may be remotely monitorable.

The apparatus may comprise a line pulling/pushing device for pulling/pushing the line, and thereby the pipe, through the borehole.

According to a second aspect of the present invention, there is provided a system for deploying a pipe within a borehole, the system comprising: the pipe deploying apparatus of the first aspect; and a pipe into which the pipe deploying apparatus is placed.

The system may further comprise a line pulling and/or pushing device for pulling and/or pushing, respectively, the line, and thereby the pipe, through the borehole.

In some arrangements the line pulling and/or pushing device may comprise a line pushing and pulling device. In this way, oscillation of the line between pushing and pulling may be used to cause the pipe to vibrate, which may free a trapped pipe from in-bore obstructions, particularly if the borehole is not level or has imperfections within it, especially at joins of one or more pipe sections.

The pipe may comprise a plurality of pipe sections. Each pipe section may be provided with a respective gripping device therein for pulling and/or pushing that respective pipe section.

According to a third aspect of the present invention, method of deploying a pipe within a borehole, the method comprising the steps of: providing a borehole; providing a pipe to be deployed into the borehole; providing the pipe deploying apparatus of the first aspect; placing the pipe deploying apparatus inside the pipe with the gripping device in the first operational state; transitioning the pipe deploying apparatus to the second operational state; and pulling and/or pushing the line so as to pull and/or push, respectively, the pipe into the borehole.

### BRIEF DESCRIPTION OF THE ACCOMPANYING DRAWINGS

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1 shows a first gripping device disposed in a pipe.

FIG. 2 shows a cross-sectional view of the first gripping device in the pipe.

FIG. 3 shows a second gripping device disposed in a pipe.

FIG. 4 shows a plan view of the second gripping device.

FIG. 5 shows a partial plan view of a third gripping device.

FIG. 6 shows a perspective view of a line tensioner.

FIG. 7 shows a cross-sectional view of a fourth gripping device in a first operational state, located in a pipe.

FIG. 8 shows a perspective view of the fourth gripping device transitioning between the first and a second operational state.

FIG. 9 shows a cross-sectional view of the fourth gripping device in the second operational state, located in the pipe.

FIG. 10 shows a partial cutaway view of a fifth gripping device disposed within an end of a pipe.

FIG. 11 shows a partial cutaway and cross-sectional view of the fifth gripping device of FIG. 10.

FIG. 12 shows a partial cutaway view of the fifth gripping device of FIG. 10 coupled by a line to a reamer.

FIG. 13 shows a partial cutaway view of a series of fifth gripping devices disposed within pipe sections, coupled to the reamer of FIG. 12.

FIG. 14 shows a partial cutaway view of a stack of fifth gripping devices on a line within a pipe.

FIG. 15 shows a cutaway view of a bore being drilled through a hillside.

FIG. 16 shows a cutaway view of a pipe being pulled back through a bore.

FIG. 17 shows a cutaway view of a pipe being pulled forward through a bore.

FIG. 18 shows a cutaway view of a pipe being pushed forward through a bore.

### DETAILED DESCRIPTION

The present invention will be described with respect to certain drawings but the invention is not limited thereto but only by the claims. The drawings described are only schematic and are non-limiting. Each drawing may not include all of the features of the invention and therefore should not necessarily be considered to be an embodiment of the invention. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that operation is capable in other sequences than described or illustrated herein. Likewise, method steps described or claimed in a particular sequence may be understood to operate in a different sequence.

Moreover, the terms top, bottom, over, under and the like in the description and the claims are used for descriptive purposes and not necessarily for describing relative positions. It is to be understood that the terms so used are interchangeable under appropriate circumstances and that operation is capable in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term “connected”, used in the description, should not be interpreted as being restricted to direct connections only. Thus, the scope of the expression “a device A connected to a device B” should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other. For instance, wireless connectivity is contemplated.

Reference throughout this specification to “an embodiment” or “an aspect” means that a particular feature, structure or characteristic described in connection with the embodiment or aspect is included in at least one embodiment or aspect of the present invention. Thus, appearances of the phrases “in one embodiment”, “in an embodiment”, or “in an aspect” in various places throughout this specification are not necessarily all referring to the same embodiment or aspect, but may refer to different embodiments or aspects. Furthermore, the particular features, structures or characteristics of any one embodiment or aspect of the invention may be combined in any suitable manner with any other particular feature, structure or characteristic of another embodiment or aspect of the invention, as would be apparent to one of ordinary skill in the art from this disclosure, in one or more embodiments or aspects.

Similarly, it should be appreciated that in the description various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Moreover, the description of any individual drawing or aspect should not necessarily be considered to be an embodiment of the invention. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may mean only one in certain circumstances. The use of the term “any” may mean “all” and/or “each” in certain circumstances.

The principles of the invention will now be described by a detailed description of at least one drawing relating to exemplary features. It is clear that other arrangements can be configured according to the knowledge of persons skilled in the art without departing from the underlying concept or technical teaching, the invention being limited only by the terms of the appended claims.

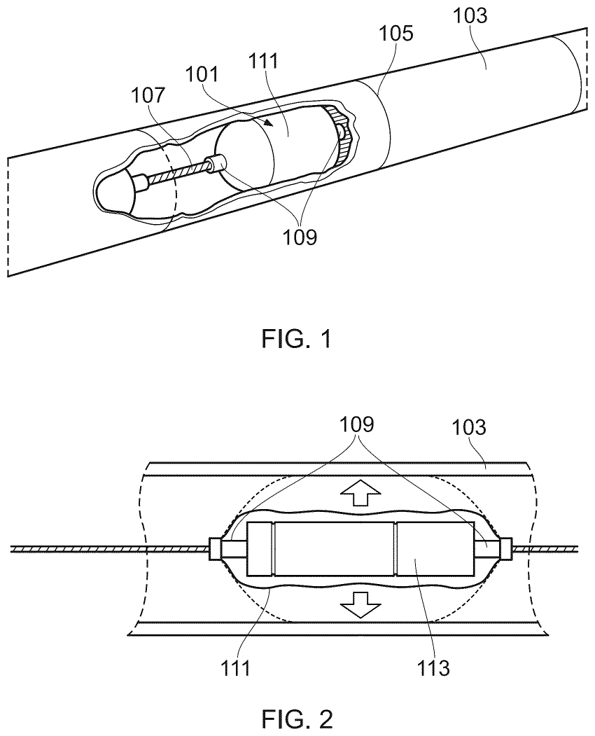

FIG. 1 shows a first gripping device 101 disposed in a pipe 103. The pipe 103 is composed of multiple pipe sections, as indicated by the joints 105 between adjacent sections.

The first gripping device 101 is connected to a line 107 by collars 109, and is shown to be composed of an inflatable bag 111, shown in its inflated state.

FIG. 2 shows a cross-sectional view of the first gripping device 101 in the pipe 103, but shown with the inflatable bag 111 in its uninflated state. Dashed lines show the same inflatable bag 111 in its inflated state, and arrows show the direction of inflation.

Between the collars 109 of the first gripping device 101 is shown the body 113 of the gripping device 101, which surrounds the line 107. The body 113 can optionally include a compressed air source and/or air pump for enabling inflation and deflation of the inflatable bag 111, and may optionally include communications and control equipment for actuating inflation and/or deflation.

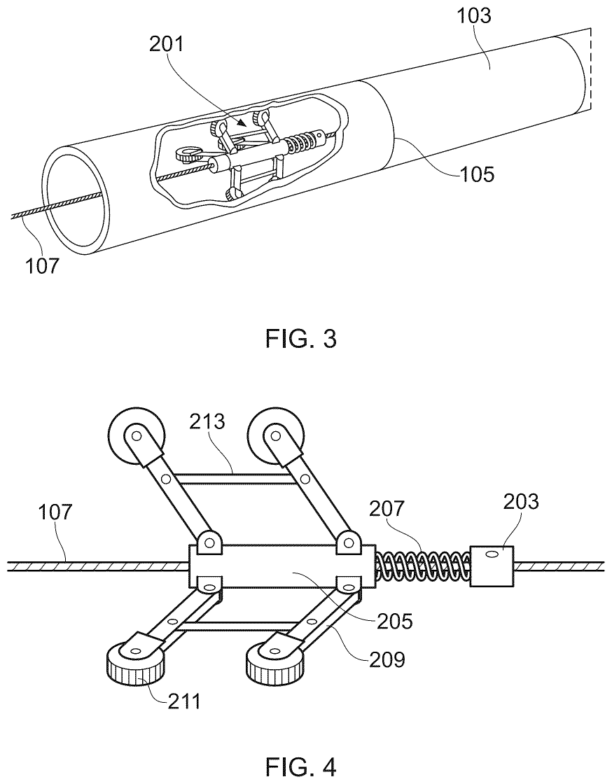

FIG. 3 shows a second gripping device 201 on a line 107, disposed in a pipe 103 with joints 105.

FIG. 4 shows a plan view of the second gripping device 201 connected to the line 107 by connection piece 203. The line 107 passes through an interior of the main body 205 of the second gripping device 201, which helps maintain orientation of the second gripping device 201 inside the pipe, but in preferred embodiments it is not rigidly attached thereto. Rather, then main body 205 is coupled to the connector piece 203 by coil spring 207, which mediates a smooth connection between the line 107 and the pipe 103. Three pairs of pivoting arms 209 are coupled to the main body 205, radially spaced apart by approximately 120 degrees. Each arm may pivot from a position substantially parallel to the line 107 (not shown) to a position projecting outward from the main body 205 such that wheels 211 disposed thereon engage with an interior of the pipe 103. In addition, the arms 209 are biased outward such that they have a tendency to push outwards to engage with the interior of the pipe 103. Each pair of arms is coupled by a coupling member 213 so that each of the pair of arms 209 pivot together.

The wheels 211 are disposed at the end of each arm, and are configured to be one-way wheels that permit rotation in one rotational sense (allowing movement down the pipe in one direction) but preventing rotation in an opposite rotational sense (prohibiting movement down the pipe in an opposing direction). The wheels have a significant gripping effect such that when a force urges the gripping device is urged down the pipe in the opposite direction, their ‘one-way’ mechanism will lock the wheels. In this way, the friction between the wheels and the pipe will enable to a force parallel to the line to be applied to the pipe to pull/push the pipe.

The effect of the arrangement of the arms 209 and the wheels 211 is such that pulling and/or pushing the line 107 to the left in FIG. 3 causes the wheels 211 to lock and the arms 209 to engage more firmly with the pipe 103. Whereas, pulling and/or pushing on the line 107 to the right in FIG. 3 causes the wheels 211 to rotate, and the arms 209 to engage less firmly with the pipe 103.

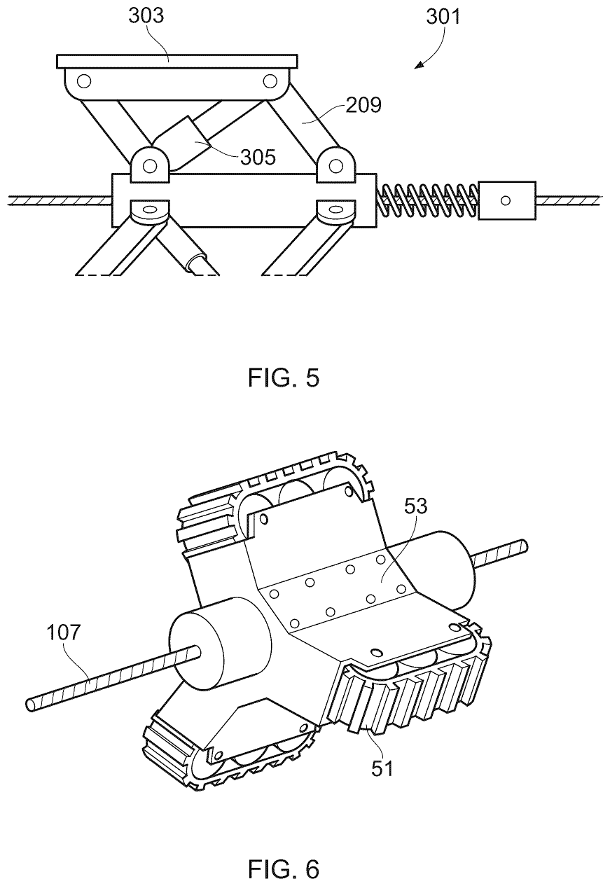

FIG. 5 shows a partial plan view of a third gripping device 301 that differs from the second gripping device 201 of FIG. 4 by replacing the wheels 211 with a high-friction pad 303 extending between the paired arms 209, and additionally comprising an actuating piston 305 for pushing the high-friction pad 303 outward toward the pipe 103, or retracting the high-friction pad 303 back again.

FIG. 6 shows a perspective view of a line tensioner on a line 107. The tensioner is configured to be movable along the line 107 by virtue of an internal motor with a housing 53 which can operate the three radially-spaced sets of caterpillar tracks 51. The tensioner is capable of pulling on the line to control tension in front and behind it, such as by taking up any slack. The tracks 51 are configured to be extendible to allow the tensioner to brace itself within the pipe 103.

In principle, the mechanical components of the tensioner, such as the extendible tracks 51, could be employed in an alternative gripping device 301.

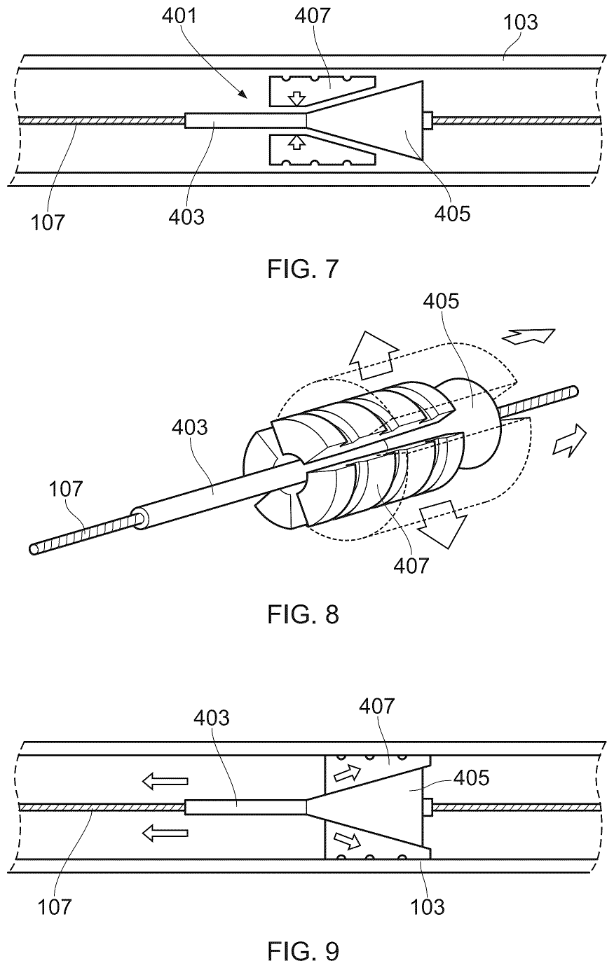

FIG. 7 shows a cross-sectional view of a fourth gripping device 401 disposed on a line 107 in a first operational state, located in a pipe 103. The fourth gripping device 401 comprises a central guide 403 through which the line 107 passes, and a cone section 405 disposed thereon. Around the central guide 403 and the cone section 405 are wedges 407 that are configured to be biased outward toward the pipe 103.

FIG. 8 shows a perspective view of the fourth gripping device 401 transitioning between the first operational state (with the wedges 407 shown in solid lines) and a second operational state (with the wedges 407 shown in dashed lines).

FIG. 9 shows a cross-sectional view of the fourth gripping device 401 disposed on the line 107 in the second operational state, located in the pipe 103. As can be appreciated, as the line 107 is pulled and/or pushed to the left in the figures, the cone section 405 slides passed the wedges 407 and pushes them outward with increasing force, thereby gripping the pipe 103 more strongly. In contrast, if the line 107 were pulled and/or pushed to the right in the figures, the cone section 405 would slide out from between the wedges 407, reducing the force with which they push against the interior of the pipe 103 and permitting them to slide with the cone section 405 to the right.

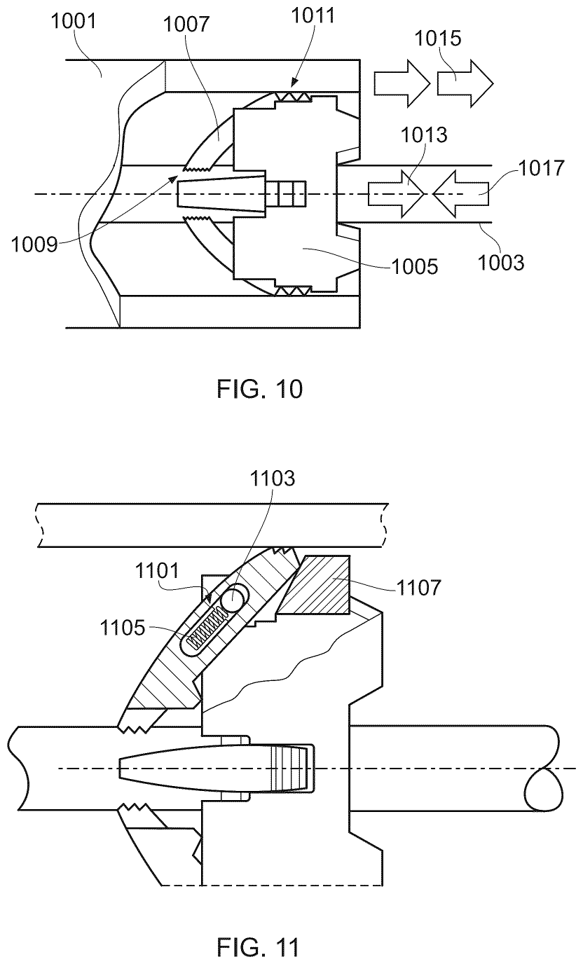

FIG. 10 shows a partial cutaway view of a fifth gripping device disposed within an end of a pipe 1001, and slidably received on a line 1003. The fifth gripping device comprises a body 1005 that surrounds the line 1003, and four arms 1007 each configured to pivot about a respective intermediate point (not shown) coupled to the body 1005. An inner end 1009 of each arm 1007 is provided with an inner high-friction surface (e.g. teeth) for gripping the line 1003 about which the body 1005 is disposed. An outer end 1011 of each arm 1007 is provided with an outer high-friction surface (e.g. teeth) for gripping an interior of the pipe 1001.

Moving the line 1003 to the right of the figure in the direction of the arrow 1013 causes the inner end 1009 of each arm to move to the right with the line, and thereby cause the outer end 1011 to pivot outward and grip the pipe more securely. Thus, moving the line 1003 to the right automatically causes the fifth gripping device to grip the pipe, and pull the pipe to the right, also in the direction of the arrows 1015.

In contrast, moving the line 1003 to the left of the figure in the direction of the arrow 1017 causes the inner end 1009 of each arm to move to the left with the line, and thereby cause the outer end 1011 to pivot inwards and release its grip on the pipe. Thus, moving the line 1003 to the left automatically causes the fifth gripping device to release its grip on the pipe.

FIG. 11 shows a partial cutaway and cross-sectional view of the fifth gripping device of FIG. 10, showing the structure of one arm 1007, which includes a slot 1101 therein, through which a peg 1103 on the body 1005 passes through, and about which the arm 1007 is free to rotate.

A biasing member, in this instance a coil spring 1105, urges the arm inward toward the line 1003 from the peg 1103, such that there is always some minimum friction between the line 1003 and the arm 1007. Similarly, a stop block 1107 aligns the fifth gripping device within the pipe and prevents movement of the outer end 1011 of the arm 1007 too far away from the inner surface of the pipe 1001.

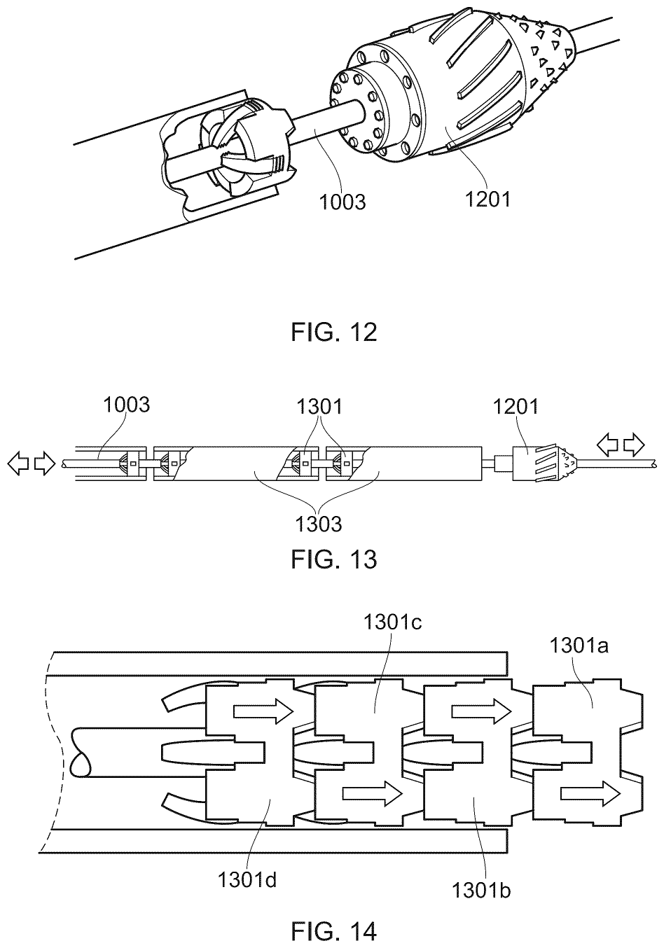

FIG. 12 shows a partial cutaway view of the fifth gripping device of FIG. 10 coupled by a line 1003 to a typical reamer 1201. It is to be appreciated that any design of reamer may be appropriate.

FIG. 13 shows a partial cutaway view of a series of fifth gripping devices 1301 disposed within pipe sections 1303, coupled to the reamer 1201 of FIG. 12. Once reaming and deployment of the pipe in the bore is complete, reamer 1201 may be removed from the line 1003, and the line 1003 may be moved to the left in the figure, in the manner described in FIG. 10. A line stop (not shown) on the now free end of the line 1003 (previously occupied by the reamer) may pull a first one of the fifth gripping devices 1301a with it. The line 1003 passes through the centre of the remaining fifth gripping devices 1301b-d, until the first one of the fifth gripping devices 1301b abuts the a second one 1301b of the fifth gripping devices, and so on, thereby pulling each of the fifth gripping devices 1301a-d with it, resulting in the arrangement of FIG. 14.

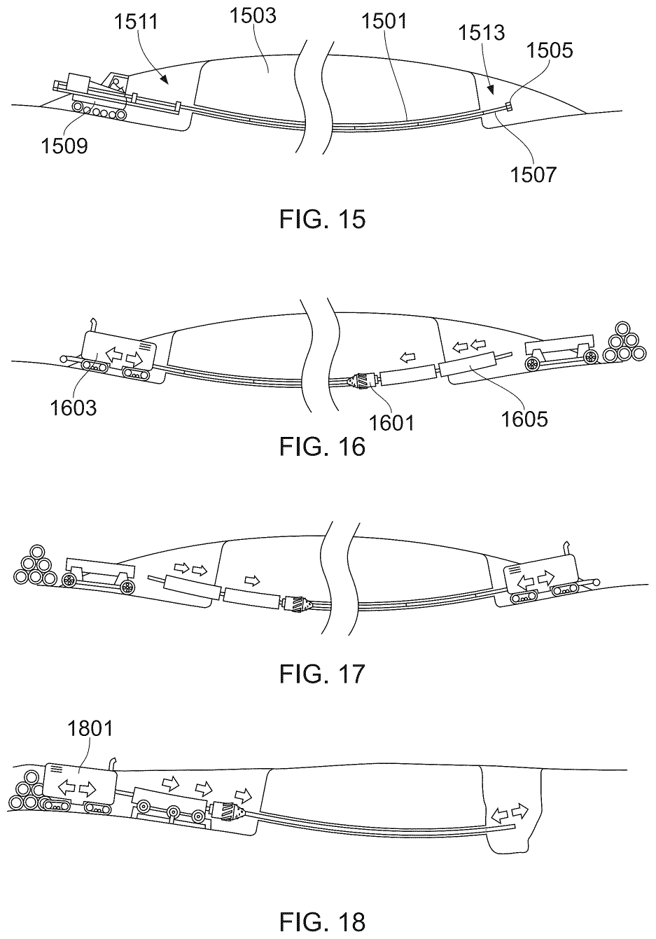

FIG. 15 shows a cutaway view of a bore 1501 being drilled through a hillside 1503 using tooling 1505 on a drill string 1507, and driven by a drilling driver 1509. As can be seen, in order to access each end of the bore, part of the hillside has been excavated at each end 1511, 1513.

FIG. 16 shows a cutaway view of a pipe being pulled back through the bore 1501 of FIG. 15. The drill string 1507 is pulled back through the bore 1501 by a pulling device 1603 that replaces the drilling driver 1509, with a reamer 1601 attached to the free end thereof, replacing the tooling 1505. Behind the reamer 1601 is provided sections of pipe 1605. Access to both ends of the bore 1501 are required in this arrangement, making the excavations 1511, 1513 necessary.

FIG. 17 shows a cutaway view of a pipe being pulled forward through the bore 1501 of FIG. 15, as an alternative to FIG. 16. The tooling 1505 is removed from the free end of the drill string 1507 and replaced with the pulling device 1603. The reamer 1601 replaces the drilling driver 1509. Behind the reamer 1601 is provided sections of pipe 1605. Access to both ends of the bore 1501 are required in this arrangement, making the excavations 1511, 1513 necessary.

FIG. 18 shows a cutaway view of a pipe being pushed forward through a bore. In this arrangement, the excavations 1511, 1513 are not necessary, as a pushing device 1801 can replace the drilling driver 1509, pushing the reamer 1601 and pipe sections 1605, without requiring significant access at the distal end of the bore.

1. A pipe deploying apparatus comprising:
a flexible line suitable for passage down an interior of a pipe to be deployed;
at least one gripping device disposed on the line, the gripping device having:
a first operational state in which the gripping device is suitable for passage through the interior of the pipe to be deployed; and
a second operational state in which the gripping device is configured to grip an interior of the pipe to be deployed,
wherein the gripping device comprises three pairs of arms, each one of the arms movable between the first operational state in which each respective arm is in a respective first position, and the second operational state in which each respective arm is in a respective second position, each respective arm in the respective second position extending from an axis of the gripping device further than the respective arm in the respective first position;
wherein each pair of arms is coupled by a coupling member;
wherein either wheels are disposed on the arms, or high friction pads are disposed between each pair of arms, for engaging with an interior of the pipe; and
wherein the gripping device is configured to travel along the line.

2. The apparatus of claim 1, wherein the gripping device comprises at least one inflatable bag, wherein the inflatable bag is in the first operational state when the bag is uninflated, and is in the second operational state when the bag is inflated.

3. The apparatus of claim 1, wherein the gripping device comprises at least one wedge, the wedge configured such that tension and/or compression on the line in a first direction causes the wedge to move radially outward from the line into the second operational state, and tension and/or compression on the line in a second direction causes the wedge to move radially inward to the line into the first operational state.

4. The apparatus of claim 1, wherein the first operational state comprises the gripping device having a first contact of a first resistance with the interior of the pipe, and the second operation state comprises the gripping device having a second contact of a second resistance with the interior of the pipe, the first resistance being lower than the second resistance.

5. The apparatus of claim 1, further comprising a line tensioner and/or compressor configured to ensure that a first tension and/or compression in a first section of line on a first side of the gripping device equals a second tension and/or compression in a second section of line on a second side of the gripping device.

6. The apparatus of claim 1, wherein the at least one gripping device comprises a plurality of gripping devices.

7. A system for deploying a pipe within a borehole, the system comprising:
the pipe deploying apparatus of claim 1; and
a pipe into which the pipe deploying apparatus is placed.

8. A method of deploying a pipe within a borehole, the method comprising the steps of:
providing a borehole;
providing a pipe to be deployed in the borehole;
providing the pipe deploying apparatus of claim 1;
placing the pipe deploying apparatus inside the pipe with the gripping device in the first operational state;
transitioning the pipe deploying apparatus to the second operational state; and
pulling the line so as to pull the pipe into the borehole.
